(19) United States
(12) Patent Application Publication
(10) Pub. No.: US 2012/0186462 A1
(43) Pub. Date: Jul. 26, 2012

(54) DEVICE FOR FOAMING MILK

(76) Inventor: Volker Breust, Kiel (DE)

(21) Appl. No.: 13/349,235

(22) Filed: Jan. 12, 2012

(30) Foreign Application Priority Data
Jan. 21, 2011 (DE) 202011001811.3

(51) Int. Cl. A01J 11/04

(52) U.S. Cl. 99/466

(57) ABSTRACT

A device for foaming milk with a motor arranged in a housing, for driving a driving shaft in rotation, and a foaming element arranged on a first housing end outside of the housing, coupled to the driving shaft, which set in rotation by the latter about a rotation axis. The device includes a supporting means arranged on the housing, on which means the device can be set down with first housing end located in a low position such that the foaming element rotates freely, and wherein the rotation axis extends at an inclination with respect to the vertical. The device for foaming milk, designed in this manner, produces a milk foam which is of a quality that can be generated in apparatuses of the state of the art, wherein at the same time the handling is simplified for the operator, and requires less attention from him/her.

### CROSS-REFERENCE TO RELATED APPLICATIONS

This application claims priority from German Patent Application Serial No. DE202011001811.3, filed Jan. 21, 2011, the entire specification of which is incorporated herein by reference.

### BACKGROUND OF THE INVENTION

1. Technical Field

The present invention relates to a device for foaming milk.

2. Background Information

Foamed milk is an essential component in the preparation of coffee drinks mixed with milk, for example, cappuccino, latte macchiato, and the like. However, it is also used as an additive for other drinks, for example, tea, in the preparation of cacao, or enjoyed in its pure form. When foamed milk is used to refine or prepare hot drinks in particular, the milk foam is prepared from warmed or heated milk.

In the sense of this invention, milk here denotes not only an animal product, in particular cow's milk, but also goat milk, sheep milk, milk from horses, and the like, but also milk substitute products prepared on a plant basis, such as, particularly, soy milk or rice milk, which can also be foamed, although with varying result.

Besides devices in which milk is simultaneously heated and foamed by introducing hot steam into it, and which are frequently found in espresso machines or fully automated coffeemakers, devices also exist which mix the milk by means of rotating foaming elements, similar to an eggbeater, with air, and foam it in this manner. Such apparatuses are known particularly as handheld apparatuses, as described, for example, in DE 202 05 449 U1 or DE 20 2008 016 164 U1.

With such handheld apparatuses, milk which has been heated in a suitable receptacle on a stove, in a microwave oven, or in another suitable manner, is typically foamed until a desired degree of foam formation has been reached, making it possible to use the milk foam for additional purposes.

In general, such eggbeater-like devices produce foamed milk which has a better consistency of the milk foam for use in comparison to milk foam produced by introducing hot steam into milk.

However, the previously known handheld devices for foaming milk are also associated with disadvantages:

Thus, a person who wants to foam milk must hold the apparatus or the device for foaming milk in their hands when using the apparatus to foam milk in the receptacle and must do so throughout the entire foaming process, and consequently they cannot engage in any other activities during that time, for example, activities relating to the preparation of the drink to be mixed with the milk foam. Furthermore, the milk is typically heated first without the use of the handheld apparatus, and thus there is a risk here of the milk scorching or sticking to the bottom of the receptacle, particularly if the heating takes place on a stove. The milk often needs to be stirred in addition during this heating phase in the receptacle, to prevent such sticking.

Here too, the person who wants to prepare foamed warm milk must monitor the process appropriately, and his/her attention and activity are thus engaged.

### BRIEF SUMMARY OF THE INVENTION

The aim of the invention is to provide a remedy by producing a device for foaming milk which results in a milk foam which is of the quality achieved using the above-described apparatuses from the state of the art, but which is easier to operate by the operator, and requires less attention.

The problem is solved by a device for foaming milk as described hereunder.

The essential idea of the invention now is to design a device for foaming milk by means of a foaming element which is driven in rotation, in which a motor for driving the driving shaft, to which the foaming element is coupled, is arranged in a housing, in such a manner that it can be set down firmly, with the housing end on which the foaming element is arranged in a low position, wherein, in this position, the foaming element can turn freely, and the rotation axis about which the foaming element turns extends at an inclination with respect to the vertical.

In such a design, the device according to the invention can indeed be set down with the foaming element in a low position in the receptacle which contains the milk to be foamed, while the foaming element rotates, driven by the motor, and foams the milk. Due to the inclination of the rotation axis with respect to the vertical, according to the invention, wherein the rotation axis deviates particularly clearly from the horizontal, one prevents the generation of suction when the foaming element rotates, suction which pulls said element in the direction of the bottom of the receptacle. Rather, a current that flows along the receptacle bottom is generated in the receptacle containing the milk to be foamed, current which, in addition to the foaming effect of the foaming element, also ensures a thorough mixing of the milk contained in the receptacle, and thus contributes to the formation of a milk foam with excellent consistency.

The device according to the invention can be placed into the receptacle with cold milk, in particular with the rotating foaming element already rotating, in order to ensure at the same time a movement of the milk in the receptacle during the heating of the milk, thus preventing sticking and scorching of the milk. Besides the foaming, the device according to the invention thus also ensures the stirring of the milk, which would otherwise be needed to achieve a uniform heating during the heating process, particularly on a stove.

The inclination of the rotation axis with respect to the vertical is preferably less than or equal to 45°. In this manner, one prevents the spraying of the milk that is set in motion by the foaming element, which is observed if the rotation axis is inclined further. The inclination angle of the rotation of axis with respect to the vertical, in the set down position on the supporting means, is preferably considerably less than 45°, particularly between 5 and 20°, particularly preferably between 10 and 15°, where an inclination of approximately 13° has been found to be particularly suitable. In the case of such an inclination, the mixing effect which has been described above, and which has a positive influence on the foaming result, can still be achieved, wherein the inclined position of the rotation axis, and thus the tilting of the foaming element is kept sufficiently small in order to prevent, on the one hand, splashing as much as possible, and, on the other hand, to also reliably enable sufficient foaming of the milk, even it the filling level in the receptacle is low. If the filling level of the milk is sufficiently low so that, even if the rotation axis is inclined in this manner, a portion of the foaming element still protrudes out of the milk contained in the receptacle, and thus the device tends to produce splashes when operated, it may be possible to first introduce the device by hand, with the rotation axis oriented substantially along the vertical, into the receptacle, until there is a sufficient volume increase due to the formation of an initial foam, and then, after a certain initial volume of the foam has been reached, set it down on the supporting means in the inclined manner according to the invention.

The housing is advantageously an elongated device, so that even after the formation of the foam, it still extends out of the milk foam in a manner so its end can be sufficiently gripped by an operator. In the process, the housing can present in particular a substantially circular cross section in an elongated housing, wherein this cross section is not the only possible one. Polygonal cross sections or cross sections of other shapes (oval or the like) can be selected equally.

A length of the housing of 10-20 cm along the long side has been found to be easy to handle, and successful in practice.

In practice, the housing can accommodate, in addition to the motor, a power source for the power supply of the motor, or such a power source is arranged in the housing, wherein it is preferred to select a primary battery or several primary batteries or one or more secondary battery(s) as power source.

For a simple cleaning of the device after use, it is advantageous if the foaming element is easy to detach from its coupling to the driving shaft. A particularly simple variant which is easy to clean and operate is obtained if, on the first housing end, the housing presents a cylindrical housing section in which the driving shaft extends in the housing interior, and in which driving magnets are arranged on the driving shaft. In this variant, the foaming element presents a circular recess allowing the setting down on the cylindrical housing section, and coupling magnets on the circular recess, for coupling to the driving magnets. In this manner, the driving motor together with the driving shaft is encapsulated in the housing by the cylindrical housing section. The foaming element moves on the outer side of the housing section rotating around the latter, and it is coupled to the driving shaft by the magnetic attraction force between the driving magnets and the coupling magnets. For cleaning, but also for a possibly required exchange of the foaming element, the latter can be pulled off the cylindrical housing section, simply by overcoming the magnetic coupling forces. For cleaning, the foaming element can then be rinsed off, for example, under flowing water, and the remaining portion of the device, particularly the area of the housing which has come in contact with milk or milk foam, can also be subjected to a simple cleaning (rinsing off with water, wiping with a rag or the like).

Various possibilities can be considered as supporting means. The supporting means can be embodied entirely in a single section formed or arranged on the housing, which comprises, for example, a continuous application surface with an inclination with respect to the rotation axis in accordance with its inclination with respect to the horizontal.

One possibility of designing the supporting means, which is feasible with relatively little material use while at the same time allowing numerous design options, is for the supporting means to contain two supporting braces arranged with offset about the rotation axis, and formed on the housing. For the complete and reliable bracing of the device in the position set down on the supporting means, it is possible to provide that the supporting means furthermore encompass an outer section of the cylindrical housing section. In this manner, one gets a three-point bearing which, if the supporting braces are oriented appropriately, results in a very stable standing position, even if the foaming element is rotating, and thus generates counter forces acting on the device.

The stability can be achieved particularly if the supporting braces are offset by an angle of 45-75° about the rotation axis.

In order to prevent the foaming element from colliding with the receptacle margin—in the case where the device which has been set down in the receptacle has moved close to the receptacle margin—and thus being impeded in terms of rotating freely, a collar-like protrusion can be provided in the area of the first housing end, which extends over the outer margin of the foaming element. If two supporting braces are formed on the housing, this collar-like protrusion extends in any case into the area facing the angle section between the supporting braces.

In principle, the foaming element can be any element that is suitable for foaming milk. Here, it is preferred to use a foaming element having a circular spiral which is arranged substantially perpendicularly with respect to the plane lying in the plane of rotation, as is basically known from the state of the art referred to already above.

An additional improvement of user comfort is provided by the device according to the invention in an advantageous embodiment, wherein the device may contain a temperature sensor arranged on the first housing end, and comprise means to display a temperature measured with the temperature sensor. As means for displaying a temperature measured with a temperature sensor, reference is made here not only to a display reproducing the appropriate temperature scale (a digital display or an analog display); rather, such means also include display and communication means which indicate to the user that a certain temperature has been reached, for example, a visual display in the form of a lamp or an LED which lights up when the temperature sensor measures a temperature of the milk to be foamed or of the milk foam, which exceeds a preset threshold value. In the same manner, this display can contain, instead of a visual signaling device, an acoustic signaling device which emits a tone or a series of tones, when the temperature sensor senses a temperature which exceeds the preset temperature.

Indeed, experiments conducted by the inventor have shown that the ideal consistency of milk foam can be reached if the milk or the milk foam is at a temperature of approximately 70-80° C. In addition, this temperature is also sufficiently high to allow the further use of the milk foam for the preparation of hot drinks, without cooling the latter excessively (for example, an espresso to be refined to a cappuccino with milk foam). Due to the temperature sensor in connection with the temperature display means, an operator can place the device, during the warming phase, with the rotating foam element, into a receptacle containing milk which initially is still cold, and devote himself/herself to the other required activities. While the milk is being warmed up, it is already being foamed, and the temperature display will let the operator know when the correct temperature has been reached, so that he/she can take the receptacle containing milk foam which is now at the optimal and the correct temperature, and continue to use the foam.

The housing of the device preferably consists, at least in a preponderant section, of a metal or a metal alloy. This confers not only a particular and good stability to the device; rather, the metal housing, due to the good heat conduction properties of the metal, will promptly remove the heat taken up from the warm milk or from the heated milk foam, and release it through its section which is in contact with the ambient air, to said ambient air, so that the components arranged in the housing, particularly the motor, but also other parts, are reliably protected from overheating.

### BRIEF DESCRIPTION OF SEVERAL VIEWS OF THE DRAWINGS

Additional advantages and characteristics of the invention can be obtained from the following description of an embodiment example in reference to the figures in the appendix. The figures show:

FIG. 1 a device according to the invention in a position set up for operation, in a side view

FIG. 2 a representation of the device according to FIG. 1 in the same position, but in a longitudinal section, and

FIG. 3 the device according to the invention in a three-dimensional view, in a position for operation.

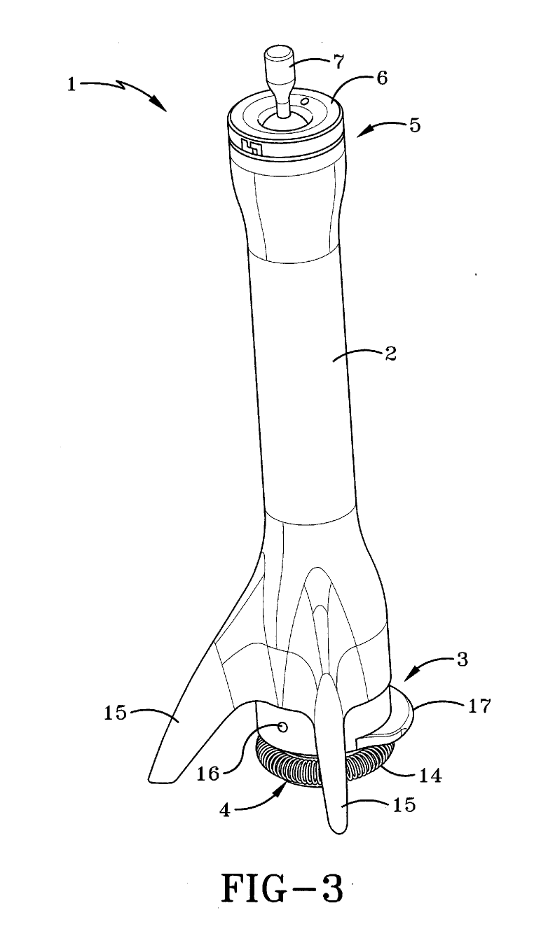

The figures show, as an example, an embodiment example of the invention, which will be described below, wherein this embodiment example represents merely a variant for carrying out the invention, which is described further and in greater detail here for an improved understanding of the invention.

### DETAILED DESCRIPTION OF THE INVENTION

The device for foaming milk, numbered with the reference numeral 1, contains a housing 2 which extends lengthwise and straight, and thus resembles the housing of a typical flashlight. In the device depicted here, the housing 2 is made of metal, preferably a zinc die cast or sintered zinc, wherein, on the outer side, the zinc is chromium-plated to improve the visual appearance, and to improve the corrosion resistance and ensure certification for food applications.

On a first housing end 3, a foaming element 4 is arranged outside of the housing. On the side facing the first housing end, the housing 2 presents a second housing end 5 which is closed by a screw cap 6 which can be screwed on. A toggle switch 7 is arranged on the screw cap 6. In the area of the first housing end 3, an independent housing section is connected here to the housing 2 which otherwise consists of a single piece in the central section, wherein said section can also be made of a different material, for example, a plastic.

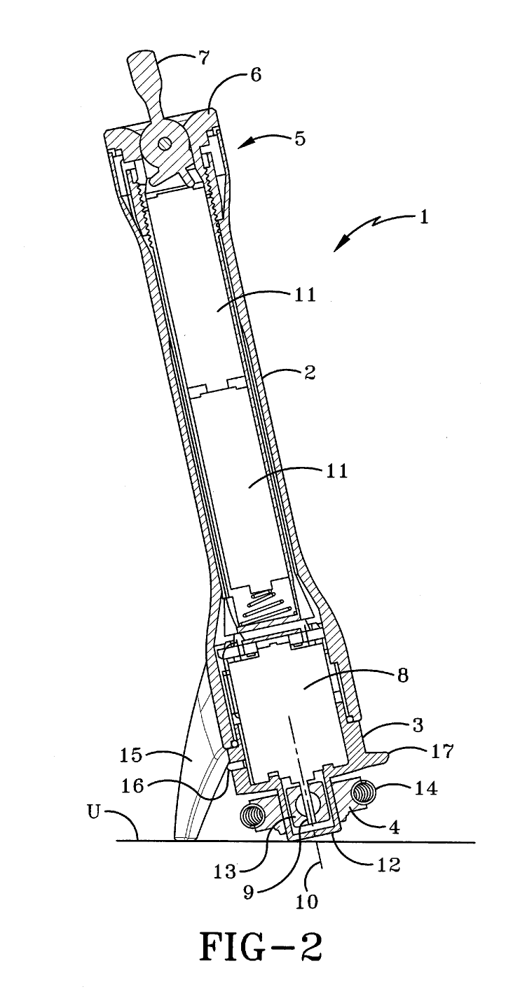

Within the housing 2, in the area of the first housing end 3, a motor 8 (see FIG. 2) is arranged, which drives a driving shaft 9 for rotation about a rotation axis 10. The motor 8 is supplied with electric power via primary batteries or secondary batteries 11 which are also located inside the housing 2. To switch the motor 8 on and off, the toggle switch 7 is used, which opens or closes the electrical contact between the primary batteries and the motor.

The foaming element 4 is substantially circular, with an opening arranged in the center. The opening in the center of the foaming element 4 is dimensioned in such a manner that it can be guided over a cylindrical housing section 12 in the area of the first housing end 3, wherein sufficient clearance remains so that the foaming element 4 can move in rotation about the cylindrical housing section 12. The driving shaft 9 extends inside the housing section 12, without perforating the housing 2. There, that is, in the interior of the cylindrical housing section 12, driving magnets 13 are in a rotationally fixed position with respect to driving shaft 19 connected to the driving shaft 9, magnets which are coupled, with the corresponding coupling magnets—not shown in further detail here—which are arranged in the foaming element 4 so they so they face the central opening, through the wall of the housing 2 in the area of the cylindrical housing section 12, to transfer in this manner the torque generated by the motor 8 from the driving shaft 9 to the foaming element 4, and to drive the latter in rotation about the cylindrical housing section 12. On its outer edge, the foaming element 4 presents a spiral 14 guided in a circle and made of a wire-like material, particularly a metal wire, to create a vortex of the milk to be foamed with air.

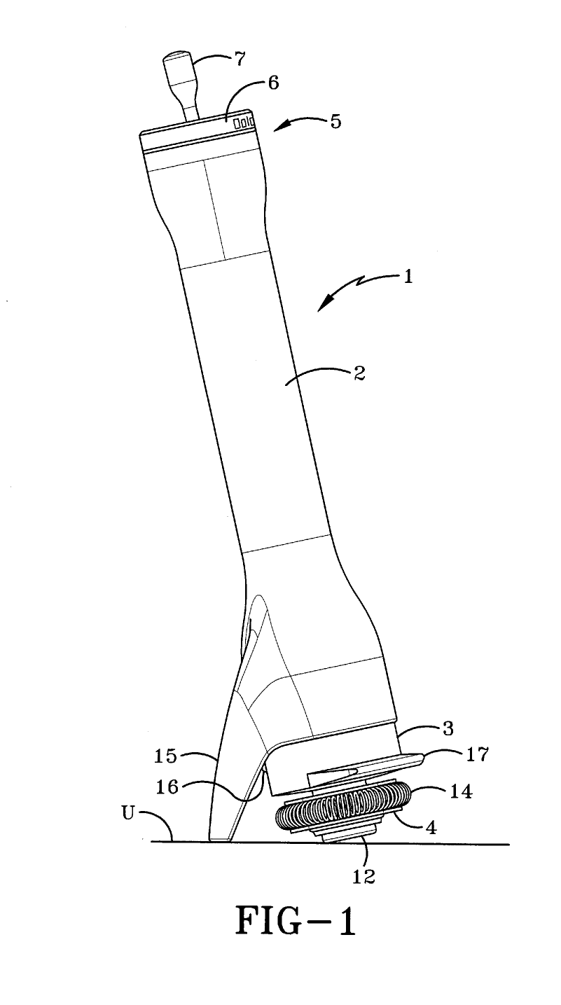

On the housing 2, in the central section thereof, two support braces 15 are formed constituting a single piece, and forming supporting means for setting down the device 1. An additional supporting means for setting down the device is formed by a marginal area of the cylindrical housing section 12. FIGS. 1 and 2 also include for illustration the support U in the representation, on which the device 1 is set down supported by the supporting braces 15, as well as the section of the housing which forms an additional supporting means in the cylindrical housing section 12, in such a manner that the rotation axis 10 about which the foaming element 4 is driven by the motor 8 is tilted with respect to the vertical (which here must be understood to be perpendicular to the support U). In this embodiment example, the angle enclosed between the rotation axis 10 and the vertical is approximately 13°.

In the area of the lower housing end 3, a temperature sensor 16 can be seen, which is arranged with a sensor tip outside of the housing in the area containing the milk when the device 1 is in use. The temperature sensor 16 detects the temperature of the milk and it is coupled (not shown in further detail here) to a temperature display device which may be not only a display of the actual temperature in ° C. or another temperature scale, but which may also consist of a simple acoustic and/or visual signaling apparatus which emits a signal as soon as the temperature sensor 16 measures a temperature that exceeds a certain preset temperature.

Finally, in an area of the lower housing end 3, which faces the supporting braces 15, a collar-shaped protrusion is formed on the housing 2, which extends beyond the periphery of the foaming element 14.

In the representation shown, one can see the special feature of the device 1 according to the invention, namely that said device, for use, can be set down in such a manner on the supporting means in the form of the supporting braces 15 and of the edge of the cylindrical housing section 12, which rests on the support U, that the foaming element 14 rotates freely, wherein the rotation axis 10 extends at an inclination with respect to the vertical. In this manner, due to the inclined position with respect to the bottom of a receptacle in which the device 1 according to the invention is located, while the milk is being foamed, a current is generated at the same time, which turns over the milk in the receptacle, ensuring not only a particularly homogenous foaming with good milk foaming result, but also a mixing of this liquid. This is particularly advantageous if the device according to the invention, as provided in a particularly preferred usage, is set down in the milk containing receptacle already during the warming process, and the motor is switched on by actuating the toggle switch 7. Indeed, in that case the device according to the invention ensures not only the foaming of the milk, but at the same time a continuous turnover of the milk, which prevents sticking or scorching of the milk to be heated in the receptacle. The collar-shaped protrusion 17 prevents the foaming element 14 from abutting against the margin of the receptacle when the device 1 is set down close to the margin of the receptacle, and from being impeded in its rotation.

Because the housing 2 extends lengthwise, it protrudes with a sufficiently large section out of the milk contained in the receptacle, so that, after the foaming process, an operator can simply and securely grip the device by the housing 2. Moreover, this also enables—promoted by the selection of metal as material for the housing 2—a reliable removal of the heat taken up from the warmed milk to the ambient air.

### LIST OF REFERENCES

1 Device for foaming milk
2 Housing
3 First housing end
4 Foaming element
5 Second housing end
6 Screw cap
7 Toggle switch
8 Motor
9 Driving shaft
10 Rotation axis
11 Primary battery, secondary battery
12 Cylindrical housing section
13 Driving magnet
14 Spiral
15 Supporting brace
16 Temperature sensor
17 Collar-shaped protrusion
U Support

1. A device for foaming milk with a motor arranged in a housing, for driving a driving shaft in rotation, and a foaming element which is arranged on a first housing end outside of the housing, coupled to the driving shaft, and which can be set in rotation by the latter about a rotation axis wherein a supporting means is arranged on the housing, on which means the device can be set down with first housing end located in a low position, in a position such that the foaming element can rotate freely, and wherein the rotation axis extends at an inclination with respect to the vertical.

2. The device according to claim 1, wherein when the housing is in the position set up on the supporting means, the inclination of the rotation axis with respect to the vertical is less than or equal to 45°.

3. The device according to claim 2, wherein when the housing is in the position set up on the supporting means, the inclination of the rotation axis with respect to the vertical is in a range between 5 and 20°.

4. The device according to claim 1, wherein the housing is an elongated housing having a substantially circular cross section.

5. The device according to claim 4, wherein the housing has a dimension in the direction of its long side of 10-20 cm.

6. The device according to claim 1, wherein in addition to the motor, a power source for the power supply of the motor is arranged in the housing.

7. The device according to claim 1, wherein the housing presents, on the first housing end, a cylindrical housing section in which the driving shaft extends in the housing interior, and in which, on the driving shaft, driving magnets are arranged, and in that the foaming element presents a circular recess for setting down on the cylindrical housing section, and, in the circular recess, coupling magnets are provided for the magnetic coupling to the driving magnets.

8. The device according to claim 1, wherein the supporting means comprises two supporting braces arranged with offset about the rotation axis and formed on the housing.

9. The device according to claim 7 wherein the supporting means furthermore encompasses an outer section of the cylindrical housing section.

10. The device according to claim 8 wherein the supporting braces are offset about the rotation axis by an angle of 45-75°.

11. The device according to claim 10, wherein a collar-like protrusion is arranged, at least in the area which is facing the angle section of 45-75°, by which the supporting braces are offset about the rotation axis, on the housing in the area of the first housing end, and which extends over the outer margin of the foaming element.

12. The device according to claim 1, wherein the foaming element presents a spiral arranged in the form of a circle in a plane which extends substantially perpendicular to the rotation axis.

13. The device according to claim 1, further comprising:
a temperature sensor arranged on the first housing end; and
a means for displaying a temperature measured by the temperature sensor.

14. The device according to claim 1, wherein the housing is made of metal or a metal alloy.

15. The device according to claim 3, wherein when the housing is in the position set up on the supporting means, the inclination of the rotation axis with respect to the vertical is in a range of between 10 and 15°.

16. The device according to claim 15, wherein when the housing is in the position set up on the supporting means, the inclination of the rotation axis with respect to the vertical is approximately 13°.

17. The device according to claim 6, wherein the power supply comprises one or more primary battery(ies) or one or more secondary battery(ies).

18. The device as defined in claim 14, wherein the housing is made from chromium-plated zinc.
